(19) United States
(12) Patent Application Publication
(10) Pub. No.: US 2026/0213419 A1
(43) Pub. Date: Jul. 23, 2026

(54) METAL BACK-CAVITY ANTENNA DEVICE

(71) Applicant: ASUSTeK COMPUTER INC., Taipei (TW)

(72) Inventors: Shih-Hsun Chang, Taipei (TW); Min-Yang Li, Taipei (TW)

(21) Appl. No.: 19/449,813

(22) Filed: Jan. 15, 2026

(30) Foreign Application Priority Data
Jan. 21, 2025 (TW) 114102612

(51) Int. Cl. H01Q 13/18; H01Q 1/24

(52) U.S. Cl. CPC H01Q 13/18; H01Q 1/241

(57) ABSTRACT

The disclosure provides a metal back-cavity antenna device arranged on a metal case, which includes a ground metal plate, a metal radiation cover plate, a metal connecting side plate, and an antenna module. In the metal back-cavity antenna device, the ground metal plate is arranged on the metal case and in contact with the metal case. The metal radiation cover plate is located on the ground metal plate, and a slot is provided on the metal radiation cover. The metal connecting side plate is connected to a long side of the ground metal plate and a first long side of the metal radiation cover plate on a same side, so that the ground metal plate, the metal connecting side plate, and the metal radiation cover plate jointly form a metal cavity. The antenna module is located in the metal cavity and mounted on the metal radiation cover plate.

### CROSS-REFERENCE TO RELATED APPLICATION

This application claims the priority benefit of Taiwan Application Serial No. 114102612, filed on Jan. 21, 2025. The entirety of the above-mentioned patent application is hereby incorporated by reference herein and made a part of specification.

### BACKGROUND OF THE INVENTION

### Field of the Invention

The disclosure relates to a metal back-cavity antenna device suitable for a metal case and including a narrow slot.

### Description of the Related Art

Currently, due to increasing requirements of consumers on product appearances, a metal casing has great advantages in mechanical strength, heat dissipation, and appearance. Increasing manufacturers designed wireless mobile devices including a metal casing in response to a market demand. However, the metal casing is prone to shield a radiation signal of a built-in antenna and has difficulty in achieving a wideband operation. In order to resolve this problem, a groove and a metal outer frame breakpoint are usually provided on the metal casing, or an antenna window is retained at a device system end, to ensure stability of a wireless signal. However, this design affects aesthetics of a product appearance. Moreover, a biggest disadvantage of a traditional solution for building an antenna in a metal casing is that an additional antenna area needs to be allocated for the built-in antenna, or a relative distance between an antenna body and a side wall of the metal casing-as well as key internal components (such as a display and a battery) -needs to be increased. This results in an excessively large size of the whole antenna, occupation of system space, and adverse impact on product appearance.

### BRIEF SUMMARY OF THE INVENTION

The disclosure provides a metal back-cavity antenna device, which is arranged on a metal case. The metal back-cavity antenna device includes a ground metal plate, a metal radiation cover plate, a metal connecting side plate, and an antenna module. In the metal back-cavity antenna device, the ground metal plate is arranged on the metal case and in contact with the metal case. The metal radiation cover plate is located on the ground metal plate. A slot is provided on the metal radiation cover plate. The metal radiation cover plate includes a first long side and a second long side opposite to each other and a first short side and a second short side opposite to each other. The metal connecting side plate is connected to a long side of the ground metal plate and the first long side of the metal radiation cover plate on a same side, so that the ground metal plate, the metal connecting side plate, and the metal radiation cover plate jointly form a metal cavity. The antenna module is located in the metal cavity and mounted on the metal radiation cover plate.

Based on the above, in the disclosure, an opening side of the metal cavity is arranged to face a system end and a closed side thereof is arranged to be close to a vertical wall of the metal case, the slot is provided on the metal cavity, and an inductive coupling element and a matching element of the antenna module are used, successfully designing a new metal back-cavity antenna device. Therefore, the metal cavity is close to a side wall of the metal case without being away from a metal wall. Moreover, in the disclosure, the design in which the metal cavity is close to the side wall of the metal case significantly improves a system space utilization rate and increases product competitiveness. Furthermore, the narrow slot on the metal cavity is provided in a glass area of a display unit based on a scenario demand of an electronic device, so as to avoid being directly seen by a user, or is integrated with a heat dissipation hole of the metal case or a sound outlet hole of a horn for appearance packaging. Therefore, the disclosure also has a great development potential in appearance design. Therefore, compared with a cavity in a traditional antenna, the metal cavity used in the disclosure significantly reduces a required length and depth of the metal cavity, and is surrounded by a metal coating, which blocks an opportunity for radiation of system end noise in a specific directional through the antenna again, thereby reducing use of auxiliary materials.

### BRIEF DESCRIPTION OF THE DRAWINGS

FIG. 1 is a schematic structural diagram of a metal back-cavity antenna device according to an embodiment of the disclosure.

FIG. 2 is a schematic exploded view of the metal back-cavity antenna device according to an embodiment of the disclosure.

FIG. 3 is a structural cross-sectional view of the metal back-cavity antenna device mounted on a metal case according to an embodiment of the disclosure.

FIG. 4 is a schematic block diagram of an antenna module used on the metal back-cavity antenna device according to an embodiment of the disclosure.

FIG. 5 is a schematic structural diagram of the antenna module used on the metal back-cavity antenna device according to an embodiment of the disclosure.

FIG. 6 is a schematic structural diagram of an inductive coupling element in the antenna module according to an embodiment of the disclosure.

FIG. 7 is a schematic diagram of S parameter simulation generated by the metal back-cavity antenna device at a specific frequency according to the disclosure.

### DETAILED DESCRIPTION OF THE EMBODIMENTS

Embodiments of the disclosure are described below with reference to related drawings. Moreover, some elements or structures are omitted in the drawings in the embodiments, to clearly show technical features of the disclosure. In the drawings, same reference numerals indicate same or similar elements or circuits. It is to be understood that although terms “first”, “second”, and the like are used herein to describe various elements, components, areas, or functions, these elements, components, areas, and/or functions are not limited by these terms. These terms are only used to distinguish an element, component, area, or function from another element, component, area, or function.

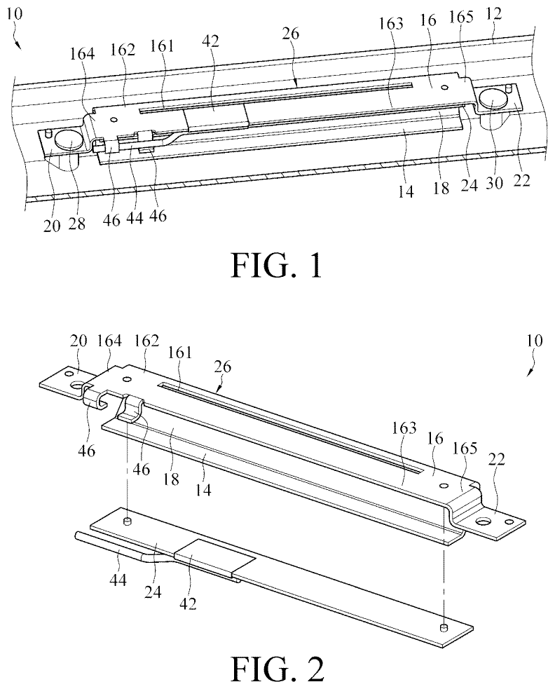

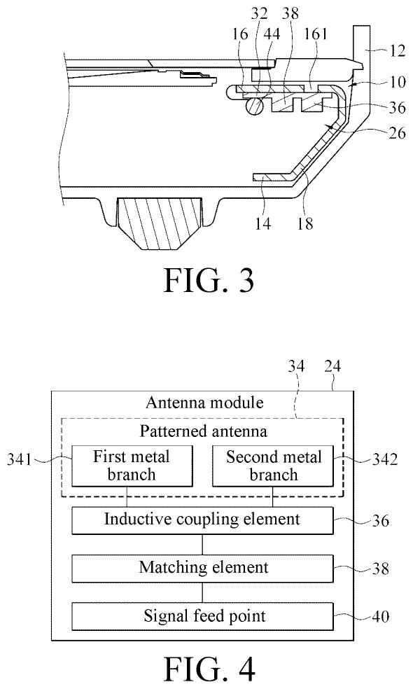

Referring to FIG. 1, FIG. 2 and FIG. 3, a metal back-cavity antenna device 10 is arranged on a metal case 12 of an electronic device, to receive and send a wireless radio frequency signal through the metal back-cavity antenna device 10. The metal back-cavity antenna device 10 includes a ground metal plate 14, a metal radiation cover plate 16, a metal connecting side plate 18, a first metal side wing 20, a second metal side wing 22, and an antenna module 24.

In an embodiment, the metal case 12 is a screen metal back cover of the electronic device (referred to as a piece A), a keyboard metal cover of the electronic device (referred to as a piece C), or a keyboard base of the electronic device (referred to as a piece D), which is not limited here. In this embodiment, the electronic device is a notebook computer or a tablet computer.

As shown in FIG. 1, FIG. 2, and FIG. 3, in the metal back-cavity antenna device 10, the ground metal plate 14 is arranged on the metal case 12, and the ground metal plate 14 is in contact with the metal case 12. The metal radiation cover plate 16 is located on the ground metal plate 14 and arranged spaced apart and in parallel. An elongated slot 161 is provided on the metal radiation cover plate 16. The metal radiation cover plate 16 includes a first long side 162 and a second long side 163 opposite to each other and a first short side 164 and a second short side 165 opposite to each other. In this embodiment, the slot 161 is close to the first long side 162 and provided along the first long side 162. A length of the slot 161 is 0.25 times a wavelength of a minimum operating frequency, and a depth of the slot 161 is 0.06 times the wavelength of the minimum operating frequency. The metal connecting side plate 18 is connected to the long side of the ground metal plate 14 and the first long side 162 of the metal radiation cover plate 16 on a same side, so that the ground metal plate 14, the metal radiation cover plate 16, and the metal connecting side plate 18 jointly form a metal cavity 26. The first metal side wing 20 is connected to the first short side 164 of the metal radiation cover plate 16, the second metal side wing 22 is connected to the second short side 165 of the metal radiation cover plate 16, a first locking element 28 (such as a screw or a bolt) extends through the first metal side wing 20 and is locked to the metal case 12, and a second locking element 30 (such as a screw or a bolt) extends through the second metal side wing 22 and is locked to the metal case 12, to mount the metal cavity 26 on the metal case 12 by using the first metal side wing 20 and the second metal side wing 22. In this embodiment, the metal cavity 26 is mounted on the metal case 12 through locking. In another embodiment, the first metal side wing 20 and the second metal side wing 22 of the disclosure fixes the metal cavity 26 on the metal case 12 through a snapping structure. In this case, the ground metal plate 14, the metal radiation cover plate 16, and the metal connecting side plate 18 of the metal cavity 26 are arranged along an inner side wall of the metal case 12, so as to be close to the inner side wall. The antenna module 24 is located in the metal cavity 26 and mounted on the metal radiation cover plate 16, so as to receive or transmit a wireless radio frequency signal through cooperation of the antenna module 24 and the metal cavity 26.

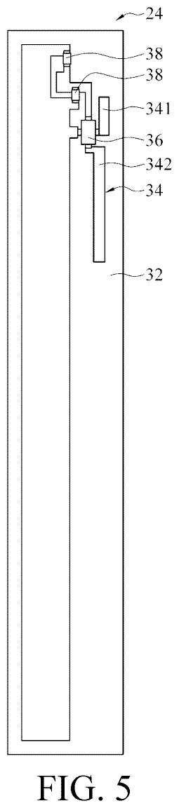

In an embodiment, refer to FIG. 3, FIG. 4, and FIG. 5 together. The antenna module 24 further includes an antenna substrate 32, a patterned antenna 34, an inductive coupling element 36, at least one matching element 38, a signal feed point 40, and a ground metal sheet 42. In the antenna module 24, the patterned antenna 34 is located on the antenna substrate 32, and the patterned antenna 34 further includes a first metal branch 341 and a second metal branch 342. The first metal branch 341 supports a 6G frequency band, and the second metal branch 342 supports a 2.4G/5G frequency band. As shown in FIG. 3, the inductive coupling element 36 is located on the antenna substrate 32 and electrically connected to the patterned antenna 34 (the first metal branch 341 and the second metal branch 342), and a position of the inductive coupling element 36 on the antenna substrate 32 corresponds to the slot 161, so as to enhance a coupling effect of the first metal branch 341 and the second metal branch 342. The matching element 38 is located on the antenna substrate 32 and electrically connected to the patterned antenna 34 and the inductive coupling element 36. The matching element 38 is an antenna aperture and impedance tuning element, such as a capacitor, an inductor, or any combination of a capacitor and an inductor. The signal feed point 40 is electrically connected to the matching element 38, and the signal feed point 40 further has a transmission line 44, such as a coaxial cable, connected thereto, for transmitting the wireless radio frequency signal, so as to feed the wireless radio frequency signal into the matching element 38 through the signal feed point 40 for impedance matching. The ground metal sheet 42 is located on the antenna substrate 32 and electrically connects the patterned antenna 34 to the metal radiation cover plate 16 to be grounded. In an embodiment, the ground metal plate 42 is a copper foil or a conductive fabric to ground the patterned antenna 34 to the metal case 12.

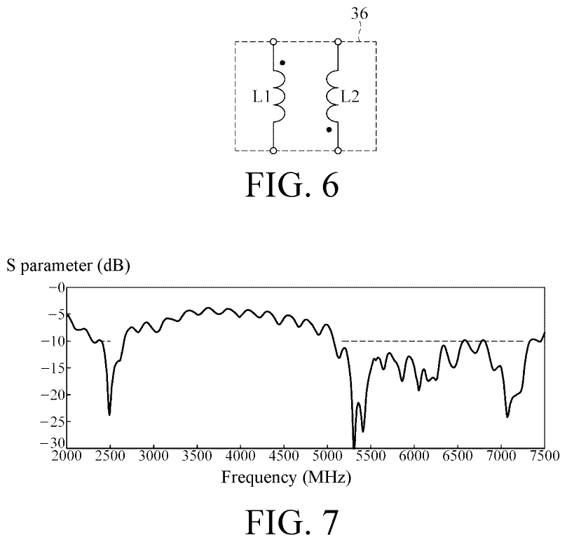

In an embodiment, refer to FIG. 5 and FIG. 6 together. The foregoing inductive coupling element 36 is composed of a first inductor L1 and a second inductor L2. The first inductor L1 as a primary side is electrically connected to the second metal branch 342 and the signal feed point 40, and the second inductor L2 as a secondary side is electrically connected to the first metal branch 341 and a ground point.

In an embodiment, because the signal feed point 40 has the transmission line 44 connected thereto, in order to fix the transmission line 44, as shown in FIG. 1 and FIG. 2, the metal back-cavity antenna device 10 further includes at least one supporting portion 46. Taking two supporting portions 46 that cooperate with each other as an example, the supporting portions 46 are located on the second long side 163 of the metal radiation cover plate 16, to mount and fix the transmission line 44 to the second long side 163.

In an embodiment, the metal cavity 26 composed of the ground metal plate 14, the metal radiation cover plate 16, and the metal connecting side plate 18 is integrally formed. In an embodiment, the metal cavity 26 composed of the ground metal plate 14, the metal radiation cover plate 16, and the metal connecting side plate 18 is made of a metal material, such as a copper, an iron, an aluminum, or an alloy thereof, which is not limited here.

In an embodiment, the ground metal plate 14, the metal radiation cover plate 16, the metal connecting side plate 18, the first metal side wing 20, and the second metal side wing 22 are integrally formed. In an embodiment, the ground metal plate 14, the metal radiation cover plate 16, the metal connecting side plate 18, the first metal side wing 20, and the second metal side wing 22 are made of a metal material, such as a copper, an iron, an aluminum, or an alloy thereof, which is not limited here.

In an embodiment, as shown in FIG. 4 and FIG. 5, the patterned antenna 34 (the first metal branch 341 and the second metal branch 342) is formed on the antenna substrate 32 by printing. In an embodiment, the antenna substrate 32 and the patterned antenna 34 thereon are a printed circuit board (PCB) on which an antenna pattern is printed. In another embodiment, the antenna substrate 32 is formed by a process such as a flexible printed circuit board (FPC), laser engraving, or a rigid-flex board. Moreover, the patterned antenna 34 (the first metal branch 341 and the second metal branch 342) is made of a conductive material, such as silver, copper, iron, aluminum, or an alloy thereof, which is not limited here.

Refer to FIG. 1 to FIG. 5 together. In the disclosure, an exciter composed of the patterned antenna 34 (the first metal branch 341 and the second metal branch 342), the inductive coupling element 36, and the matching element 38 in the antenna module 24 is configured to be coupled with the slot 161 on the metal cavity 26 to excite the metal back-cavity antenna device 10 to form a resonant mode in the 2.4G/5G frequency band and the 6G frequency band respectively. As shown in FIG. 7, S-parameter (S11) simulation is performed on the metal back-cavity antenna device 10 of FIG. 1. A result of the S-parameter simulation performed in the 2.4G/5G frequency band and the 6G frequency band is shown in FIG. 7. It is learned from a curve shown in the diagram that reflection coefficients (S11) in a low-frequency resonant mode and a high-frequency resonant mode shown in the diagram are both less than −10 dB (S11<−10 dB), indicating that the metal back-cavity antenna device 10 has a desirable reflection coefficient in both a low frequency operating band and a high frequency operating band.

In the metal back-cavity antenna device provided in the disclosure, a quantity of metal branches (patterned antennas) in the exciter and printed on the antenna substrate is not limited, to control a coupling amount with the slot of the metal cavity. Furthermore, in the present disclosure, without increasing limitations on an antenna distribution area, a required high-frequency band coupling amount is effectively controlled by using the inductive coupling element to excite additional resonance on the slot, and the matching element that optimize a dual-frequency band is arranged, so as to tune a required radiation mode and enhance adaptability of the antenna module when mounted in different environments, which is alternatively achieved through adjustment of a shape of the slot without arranging the additional matching element. Based on this, in the present disclosure, through the linear elongated slot provided close to the inner side wall of the metal case, an operating bandwidth (a low frequency band in a range of 2400-2480 MHz and a high frequency band in a range of 5150-7150 MHz) required for a wireless local area network (WLAN) system is achieved, with an antenna depth being reduced, thereby achieving dual-frequency and multi-mode operations and good radiation characteristics.

Based on the above, in the disclosure, an opening side of the metal cavity is arranged to face a system end and a closed side thereof is arranged to be close to a vertical wall of the metal case, the slot is provided on the metal cavity, and an inductive coupling element and a matching element of the antenna module are used, successfully designing a new metal back-cavity antenna device. Therefore, the metal cavity is close to a side wall of the metal case without being away from a metal wall. Moreover, in the disclosure, the design in which the metal cavity is close to the side wall of the metal case significantly improves a system space utilization rate and increases product competitiveness. Furthermore, the narrow slot on the metal cavity is provided in a glass area of a display unit based on a scenario demand of an electronic device, so as to avoid being directly seen by a user, or is integrated with a heat dissipation hole of the metal case or a sound outlet hole of a horn for appearance packaging. Therefore, the disclosure also has a great development potential in appearance design. Therefore, compared with a cavity in a traditional antenna, the metal cavity used in the disclosure significantly reduces a required length and depth of the metal cavity, and is surrounded by a metal coating, which blocks an opportunity for radiation of system end noise in a specific directional through the antenna again, thereby reducing use of auxiliary materials.

The foregoing embodiments are merely for describing the technical ideas and the characteristics of the disclosure, to enable a person skilled in the art to understand and implement the content of the disclosure accordingly, and do not constitute a limitation on the patent scope of the disclosure. In other words, equivalent changes or modifications made within the spirit disclosed in the disclosure fall within the scope of the patent application of the disclosure.

What is claimed is:

1. A metal back-cavity antenna device, arranged on a metal case and comprising:
a ground metal plate, arranged on the metal case, wherein the ground metal plate is in contact with the metal case;
a metal radiation cover plate, located on the ground metal plate, wherein a slot is provided on the metal radiation cover plate, and the metal radiation cover plate comprises a first long side and a second long side opposite to each other and a first short side and a second short side opposite to each other;
a metal connecting side plate, connected to a long side of the ground metal plate and the first long side of the metal radiation cover plate on a same side, so that the ground metal plate, the metal connecting side plate, and the metal radiation cover plate jointly form a metal cavity; and
an antenna module, located in the metal cavity and mounted on the metal radiation cover plate.

2. The metal back-cavity antenna device according to claim 1, further comprising a first metal side wing and a second metal side wing, wherein the first metal side wing is connected to the first short side, and the second metal side wing is connected to the second short side, so that the metal cavity is mounted on the metal case by using the first metal side wing and the second metal side wing.

3. The metal back-cavity antenna device according to claim 2, wherein the first metal side wing and the second metal side wing respectively lock the metal cavity on the metal case through a locking element.

4. The metal back-cavity antenna device according to claim 2, wherein the ground metal plate, the metal radiation cover plate, the metal connecting side plate, the first metal side wing, and the second metal side wing are integrally formed.

5. The metal back-cavity antenna device according to claim 1, wherein the antenna module further comprises:
an antenna substrate;
a patterned antenna, located on the antenna substrate;
an inductive coupling element, located on the antenna substrate and electrically connected to the patterned antenna;
a matching element, located on the antenna substrate and electrically connected to the patterned antenna and the inductive coupling element;
a signal feed point, electrically connected to the matching element; and
a ground metal sheet, electrically connecting the patterned antenna to the metal radiation cover plate to be grounded.

6. The metal back-cavity antenna device according to claim 5, wherein the signal feed point further has a transmission line connected thereto for transmitting a wireless radio frequency signal.

7. The metal back-cavity antenna device according to claim 6, further comprising at least one supporting portion located on the second long side of the metal radiation cover plate for mounting and fixing the transmission line to the second long side.

8. The metal back-cavity antenna device according to claim 5, wherein the matching element is an antenna aperture and impedance tuning element.

9. The metal back-cavity antenna device according to claim 5, wherein a position of the inductive coupling element on the antenna substrate corresponds to the slot.

10. The metal back-cavity antenna device according to claim 1, wherein the slot is provided near and along the first long side.

11. The metal back-cavity antenna device according to claim 1, wherein a length of the slot is 0.25 times a wavelength of a minimum operating frequency, and a depth of the slot is 0.06 times the wavelength of the minimum operating frequency.

12. The metal back-cavity antenna device according to claim 1, wherein the ground metal plate, the metal radiation cover plate, and the metal connecting side plate are integrally formed.

13. The metal back-cavity antenna device according to claim 1, wherein the ground metal plate, the metal radiation cover plate, and the metal connecting side plate are arranged along an inner side wall of the metal case.
